(19) United States
(12) Patent Application Publication
(10) Pub. No.: US 2024/0104168 A1
(43) Pub. Date: Mar. 28, 2024

(54) SYNTHETIC DATA GENERATION

(71) Applicant: INTERNATIONAL BUSINESS MACHINES CORPORATION, ARMONK, NY (US)

(72) Inventors: Victor Lara, Chino Hills, CA (US); Steven Gans, Toronto (CA); Miguel Angel Gonzalez, Santa Clara, CA (US); James Peter Griffin, Boylston, MA (US)

(21) Appl. No.: 17/934,261

(22) Filed: Sep. 22, 2022

(51) Int. Cl. G06K 9/62

(52) U.S. Cl. CPC G06K 9/6257

(57) ABSTRACT

Using a graphical user interface (GUI), a user is guided to generate a logical graph that represents how real data is generated in a situation. The situation is simulated using an artificial intelligence (AI) model a number of times by having the AI model choose paths through the logical graph to generate synthetic data that is representative of the real data. The AI model may also use a reward table that the user is guided to generate via the GUI to execute the simulation, wherein the reward table incentivizes certain paths of the logical graph, and agents of the AI model are trained using the values of this reward table. This synthetic data generated via the AI model can be used for training other AI models.

### BACKGROUND

Artificial intelligence (AI) models are quickly growing in ubiquity as their versatility and power increase. One of the most significant factors that is limiting the rate at which AI models are adopted is the fact that AI models need to be trained with accurate and representative data before the AI models can be deployed. For example, if an AI model is trained with data that is not fully accurate, then the AI model may learn false correlations as it is trained. Beyond this, if an AI model is trained with data that is not fully representative of a robust cross-sample of the real-world, then the AI model may be untrained to properly recognize and react to some situations (e.g., as a result of these situations not being adequately presented within the training data). If an AI model is not trained with an accurate and representative set of training data, the AI model is liable to eventually be unreliable and/or inaccurate in use.

A common solution to this problem is to buy and/or mine real data with which the AI model can be trained. For example, if an AI model relates to medical diagnosis, a training entity will find historical archives of relevant medical data, curate this data until it has the desired representative sets of data, and feed this to the AI model to train and test the AI model. However, regulations are increasingly limiting the ability of entities to use real data for such purposes. For example, regulations may require that specific and explicit permission be gathered from a user whenever data of that user is used for such a purpose. As such, gathering real data is often not only significantly more process-intensive, but also it is increasingly liable to have difficult-to-fix holes within the data given how much of the data can be hidden behind locked doors.

### SUMMARY

Aspects of the present disclosure relate to a method, system, and computer program product relating to generating synthetic data. For example, the method includes guiding, using a graphical user interface (GUI), a user to generate a logical graph that represents how real data is generated in a situation. The method also includes simulating, using an artificial intelligence (AI) model, the situation a number of times by having the AI model choose paths through the logical graph to generate synthetic data that is representative of the real data. This synthetic data can be used for training other AI models. By generating a system that guides a user to create a logical graph of a situation and then simulating this situation, aspects of the disclosure are able to generate a full, accurate, and representative set of training data without the need for any real data. By avoiding using real data, aspects of this disclosure side-step concerns with regulations (including the concern that targeting some data for removal to meet regulations creates hidden deficiencies within the training data is generated using real world data).

Further aspects of the disclosure relate to the method described above, wherein the logical graph is a simplified version of the situation. Beyond this, the method also includes adding additional nuanced steps within the logical graph via analyzing the simulations of the AI model once it is generated. By starting with a “simplified” version of the situation, and then adding in additional nuance following analysis of the simulation as guided by the GUI, aspects of the disclosure may improve an ability of aspects of this disclosure to arrive at a complete and accurate set of synthetic data. For example, it may be unreasonable for a user to generate a fully representative logical flowgraph of a situation in a single iteration, but by enabling a user to first create an accurate simplified version of the situation that can itself be discretely simulated and analyzed, aspects of the disclosure may enable a solution by which the situation may be iteratively fully represented for the reinforcement learning model.

Further aspects of the disclosure relate to the method described above, wherein guiding the user to generate the logical graph includes receiving positive or negative rewards associated with steps of the logical graph, wherein the positive or negative rewards define why agents of the AI model would choose different paths of the logical graph. In conventional systems, it may be difficult to capture that one instance might be more likely to occur than another instance even if the logical flowgraph is fully representative and accurate. As such, by enabling rewards to be quickly inserted into the logical graph via the GUI, aspects of the disclosure solve the problem of how to capture and simulate inherent inclinations of real-world events to follow certain pre-determined patterns (e.g., an inclination for an event to generally do a first thing rather than a second thing).

Further aspects of the disclosure relate to the method described above, wherein the logical graph includes a plurality of “subgraphs” generated by the user via the GUI. Sub graphs as used herein are essentially a smaller logical flowgraph within the “full” logical graph, where individual subgraphs can be tested independently and can be logically independent of each other, can flow into subsequent subgraphs, and/or wherein some subgraphs of the plurality of subgraphs are alternates of each other within the situation. Given that the most valuable AI models tend to relate to complex systems, in some instances it might be impractical for the logical graph to be a single graph with no discrete divisions. Specifically, conventional systems that require a single all-inclusive and indivisible graphs to represent a situation may have hidden flaws that are extremely hard to identify and fix, as larger interconnected systems inherently have more variables that can interact in unexpected ways. As such, enabling aspects of this disclosure to divide the logical graph into smaller subsections that can be individually created, tested, combined, and simulated may improve an ability to capture an accurate representation of a real-world situation.

A system and computer program configured to execute the aspects of the method described above are also described herein. The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A depicts a conceptual diagram of an example environment in which a controller feeds a reinforcement learning model information gathered from a graphical user interface (GUI) to generate synthetic data.

FIGS. 1B-1G depict example GUI representations that the controller of FIG. 1A may cause to be displayed on the user device of FIG. 1A in gathering data for the reinforcement learning model.

FIG. 2 depicts an example high-level flowgraph by which the controller of FIG. 1A may generate synthetic data.

FIG. 3 depicts a conceptual box diagram of example components of a computing system that may be used to host the controller of FIG. 1A and/or otherwise be used to generate synthetic data as described herein.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to generating training and testing data for artificial intelligence (AI) models, while more particular aspects of the present disclosure relate to guiding a user via a graphical user interface (GUI) to generate a logical graph that represents how real data is generated in a situation (including potentially having specific rewards for different branches of the logical graph) and then simulating that situation using an AI model, therein evaluating the graph and model and resultant data to hone the results. While the present disclosure is not necessarily limited to such applications, various aspects of the disclosure may be appreciated through a discussion of various examples using this context.

The ability to generate accurate and robust sets of training data for the purposes of training AI models has not kept up with the demand for these AI models, such that currently there is a robust need for improved ways of getting training data. Traditionally, training data was “real world” data, which is to say the training data was gathered as historical data from events, facts, and people that actually existed/occurred. This data had the benefit of being largely representative of what an AI model would encounter once deployed, such that an AI model trained and/or tested using this data would often be well prepared to handle real world data when it received such data “live.” However, regulations (and social pressures) against gathering and using real-world data are making it increasingly difficult to gather sufficient real-world data to train and test AI models as desired.

Conventional systems sometimes look to address this by trying to supplement real-world data with targeted synthetic data. For example, a data scientist may analyze the real-world data that was able to be gathered, and look to manually (or with a fairly “dumb” approach) generate sets of data that “plug the gaps” that the data scientist is able to find within the available real-world data. However, this becomes a process that is dependent upon the skill of the data scientist in accurately identifying these gaps, such that conventional systems lack a technical ability to supplement the real-world data. Further, a process that generally only relies on data from users that actively opt-in to their data being gathered may result in a selection bias issue, where inherently users that are more protective of their data may be consistently and categorically underrepresented in the real-world data in subtle ways that may be difficult to detect and counteract.

Aspects of this disclosure solve or address these problems that exist in the conventional solutions. For example, aspects of this disclosure relate to guiding a user to generate a logical graph that represents how real data is generated in a situation, where this logical graph is then provided to an AI model (e.g., a reinforcement learning model) in order to generate synthetic data. In some examples, the logical graph may initially be relatively coarse and may be refined across numerous iterative simulations, enabling a user to steadily “hone in” on an improved/preferred set of synthetic data.

Further, in some examples, rewards for incentivizing or penalizing some branches of the logical graph are determined. These rewards may improve an ability to reflect the real world in which some events can be known to be more likely to occur. One or more computing devices that include one or more processing units executing instructions stored on one or more memories may provide the functionality that addresses these problems, where said computing device(s) are herein referred to as a controller. By having the controller synthetically generate data in this way, aspects of the disclosure are able to entirely circumvent the problems that conventional solutions have with being unable to gather sufficient real-world data (and/or the inability to fix the problems with that real-world data once solved.

Specifically, in some embodiments the controller may include a service description language document to define a web service that may be accessed within a GUI. This GUI is configured to provide a manually manipulatable display of data that relates to a specific situation. The GUI may be configured to reflect the desired characteristics of the generated data, such as the range, mean, distribution, and the like based on the parameters entered by a user as prompted by the GUI. The GUI further prompts the user to provide positive or negative rewards to provide transfer learning to a reinforcement learning model (e.g., a general purpose reinforcement learning model).

In some examples, the controller may be configured to enable a user to generate synthetic data for a future predicted situation, even if no such data exists yet (e.g., as a result of the future situation not having yet occurred). For example, a user may be envisioning a unique upcoming event, and/or planning for a unique product launch. Towards this end, the user may be looking to train an AI model to assist with some aspects of this upcoming event or product launch, but it may be impossible to train/test such an AI model using current data (as obviously no data exists for this future unique event). As such, in some examples the controller may enable the user to walk through events that are predicted to happen based on anticipated considerations and probable states to generate sufficient synthetic data for training/test this future-ready AI model in a way that was otherwise largely impossible with conventional approaches.

The controller may generate synthetic data using a simulator (e.g., a reinforcement learning model configured to receive parameters and output data of a given scenario). For example, the controller may use the logical graph (a graph with nodes representing entities and edges that interconnect the nodes representing relationships between the nodes, where this logical graph reflects all of the simulation factors gathered through the GUI) as a “starting point” with which the synthetic data is generated. The controller enables aspects of the logical graph to be manually manipulated within the GUI, enabling an intuitive and simple way for relationships to be defined, and later updated/perfected across iterations. After the controller builds the simulation factors (e.g., the variables that constrain the situation in a realistic and/or desired manner), the controller triggers the simulation (otherwise referred to as the “simulation flow”).

The controller may trigger the simulation by passing the logical graph to a model that includes a significant number of agents (e.g., thousands of agents, or hundreds of agents, or millions of agents, depending upon the variability/volatility of the given situation being simulated). The model causes these agents to flow through the logical graph according to the rules and rewards of the logical graph. In some examples, each part of the flow is reflected in a state resulting from a decision of the agent, where this state is captured and reflected in the synthetic data. The generated logical graph enables states to connect with one or more subsequent states according to logically defined relationships, such that these states daisy-chain as the agents flow through them. Connections between the states define the choices an agent can make at a given state.

As discussed herein, the controller will also curate the reward table to aid the simulation, where the rewards provide the model with a reinforcement learning feedback loop. The reward table is a container for rewards for various choices that can be made by agents. Entries within the reward table may include a respective state at which the reward is weighed, where the amount of a given reward (whether positive or negative) is defined by the simulation factors at a given point in the simulation. Once the simulation runs, the agents are trained via values from the reward table, such that the reinforcement learning model trains during the simulation (where the accuracy of this training is improved via the rewards table). Following the simulation, the controller may generate a usable comma-separated value (CSV) file to be loaded to a system of choice, and/or injected directly into a preferred AI model workflow.

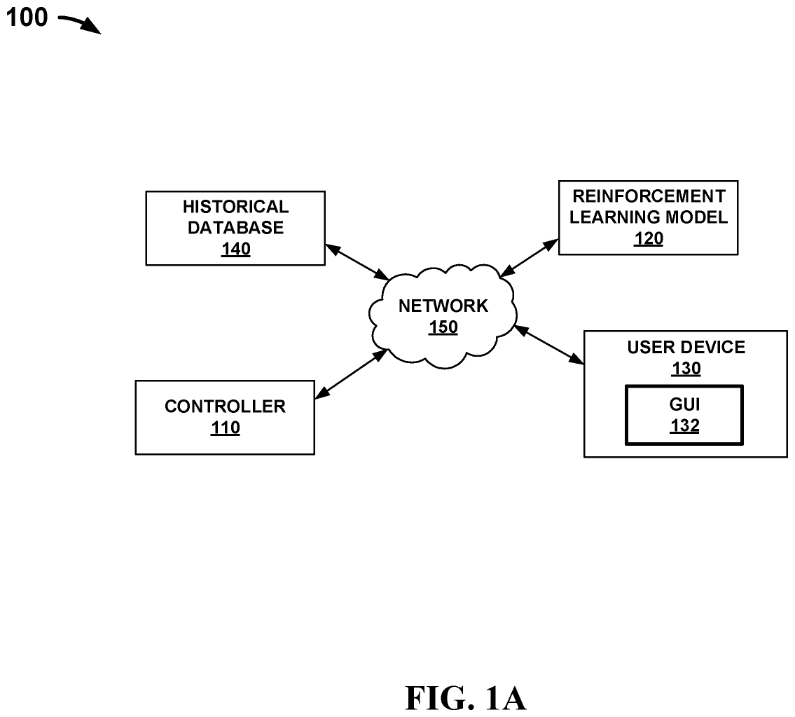

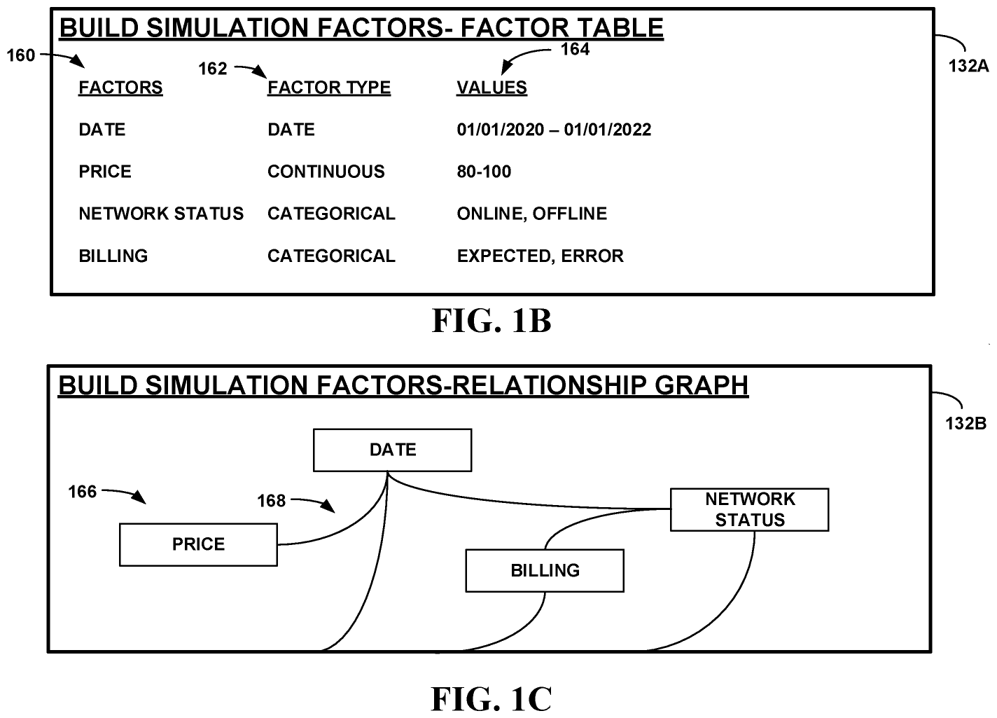

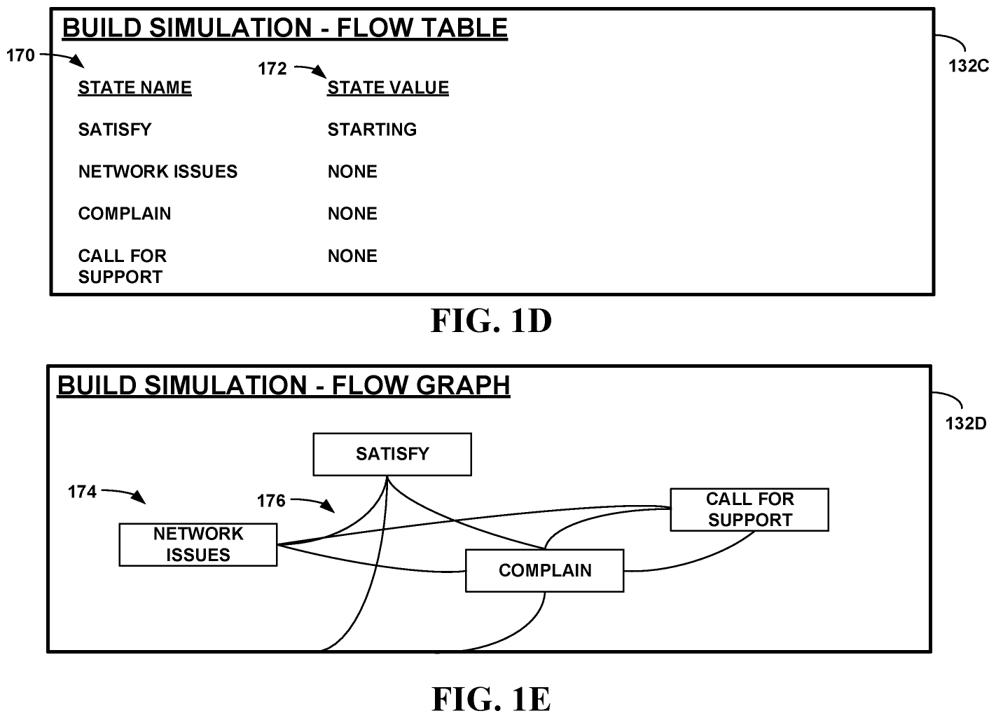

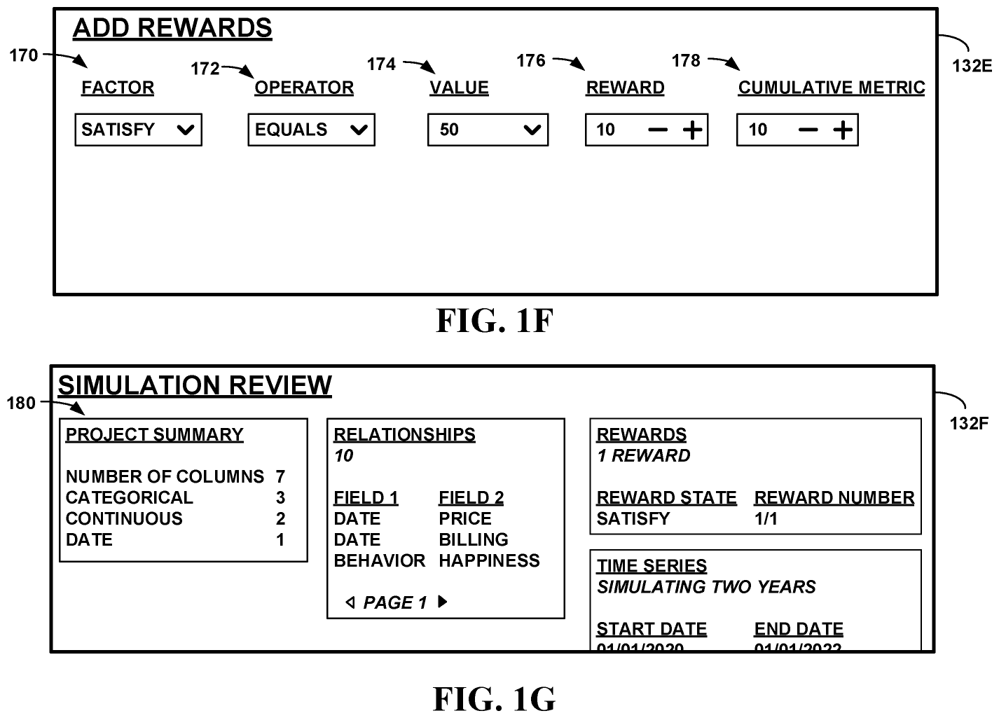

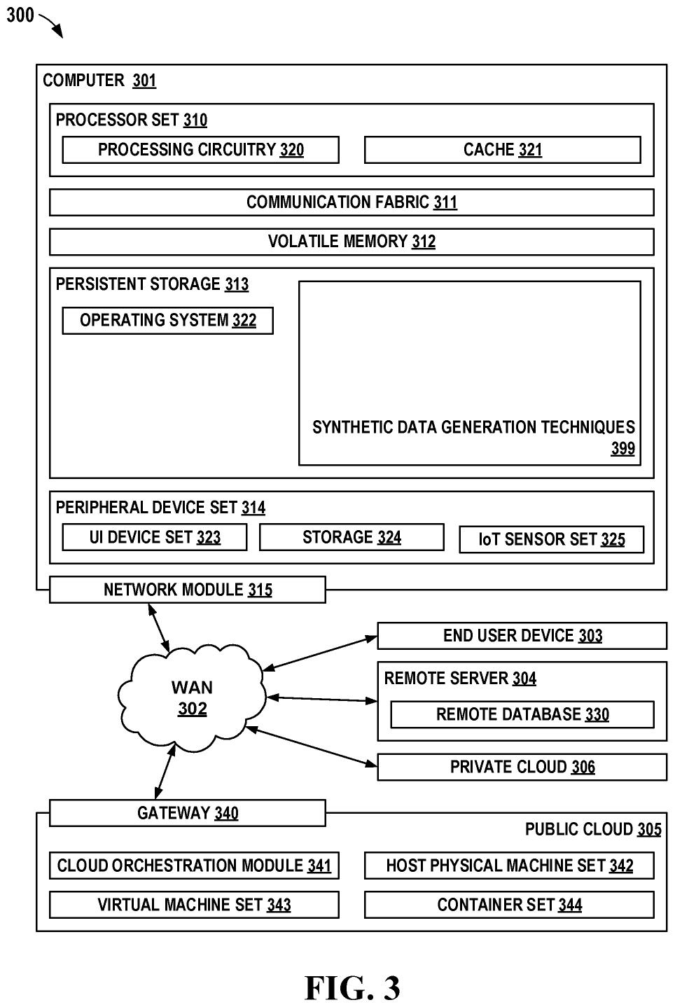

For example, FIG. 1A depicts environment 100 in which controller 110 generates synthesized data as described herein. Controller 110 may include a processor coupled to a memory (as depicted in FIG. 3) that stores instructions that cause controller 110 to execute the operations discussed herein. In some examples, controller 110 may generate synthesized data as part of an AI cloud based system. Controller 110 may generate the synthesized data via a reinforcement learning model 120 generated via GUI 132 of user device 130.

Controller 110 may use historical database 140 in order to assist a user in generating the logical graph. For example, historical database 140 may include previously used sets of parameters that may be made available to a user, such that a user could select and therein insert these historical sets of parameters wholesale (or after minor modification) into the generated logical graph. For another example, controller 110 may be continuously comparing inputs received via GUI 132 to inputs (and results thereof) of “completed” reinforcement models, logical graphs, rewards, etc., as saved within historical database 140. Controller 110 may be comparing this “live” data against the historical data in order to determine whether or not there is opportunity to suggest an improved/alternate set of parameters. Specifically, where controller 110 determines that a user is providing parameters via GUI 132 that correspond strongly with saved parameters that historically performed poorly, controller 110 may suggest a similar but different set of parameters that correspond with saved parameters that historically performed well.

In some examples, controller 110 provides the functionality described herein as client and server side applications, where user device 130 is on a client side, and controller 110, reinforcement learning model 120, and/or historical database 140 are on a server side (e.g., where in some instances one or all server-side applications are hosted on a single computing device).

Controller 110 may enable/cause (e.g., as a web application) GUI 132 to appear as discussed herein such that a user may engage user device 130 in order to setup and configure simulation projects. Once the user has provided sufficient data to controller 110 through GUI 132, controller 110 may orchestrate and execute simulation jobs that synthesize data, train and run reinforcement learning model 120, and generate data results.

Controller 110 may interact with other server side devices using network 150. Network 150 may include a computing network over which computing messages may be sent and/or received. For example, network 150 may include the Internet, a local area network (LAN), a wide area network (WAN), a wireless network such as a wireless LAN (WLAN), or the like. Network 150 may comprise copper transmission cables, optical transmission fibers, wireless transmission, routers, firewalls, switches, gateway computers and/or edge servers. A network adapter card or network interface in each computing/processing device (e.g., computing devices that host/include reinforcement learning model 120 and/or historical databases 140) may receive messages and/or instructions from and/or through network 150 and forward the messages and/or instructions for storage or execution or the like to a respective memory or processor of the respective computing/processing device. Though network 150 is depicted as a single entity in FIG. 1A for purposes of illustration, in other examples network 150 may include a plurality of private and/or public networks.

Using the web application as viewed via GUI 132, users can define a situation for which they would like controller 110 to generate synthetic data. Specifically, users may define a logical graph that includes factors that change the situation, set up statistical relationships between these factors, create simulation states (and establish way points to connect these simulation states), and establish rewards and other values to configure the simulation. As guided by controller 110, a process of setting up and configuring a project consists of two main steps. The first step is configuring factors to synthesize data inputs that represent choices for agents of reinforcement learning model 120. The second step is the simulation setup and configuring where the users can define simulation states. FIGS. 1B-1G illustrates, at a high level, examples of GUI 132A-132F (which are examples of what may be generated on GUI 132) the steps to generate synthetic data.

FIG. 1B depicts GUI 132A in which users are enabled to create factors 160. Some factors 160 are used as input for reinforcement learning model 120 to make choices during the simulation, while other factors 160 are used as output when producing data. To ease the process, controller 110 may enable GUI 132A to name each of factors 160. A user may define whether an input factor is categorical or continuous. For categorical factors, GUI 132A enables the user to manually enter the category values. For continuous factors, GUI 132A enables the user to set a minimum and maximum value. For output values, GUI 132A enables date and cumulative metric. Date factors are used to set the timeline of the simulation and can be configured to have a distribution of seasonality and time-series. GUI 132A enables cumulative metric factors to be initialized to have a starting value, where agents of reinforcement learning model 120 can increase or decrease this initial value (e.g., using the rewards in the simulation states) based on choices of the respective agent. GUI 132A enables the creation of the project, including providing and configuring the factors 160, in a single simple form in the web application.

FIG. 1C depicts GUI 132B of a second step in the logical graph creation process in which users are enabled to set statistical relationships among factors. The web application offers a node-edge graph canvas where each node 166 represents a respective factor 160 and respective edges 168 represent a statistical relationship between two factors 160. GUI 132B enables user to connect two factors 160 and configure the relationship using diagrams and graphs as inputs. GUI 132B offers a variety of diagrams and graphs for the user to use as data inputs. While in other solutions diagrams and graphs may be used as outputs to visualize data, GUI 132B (as provided via controller 110) enables graphs to provide inputs to enable the user to visualize their data inputs and make necessary adjustments based on their goals and/or requirements.

FIG. 1D depicts GUI 132C of a third step in which a user is enabled to create simulation states. As used herein, simulation states include choices an agent can make over the time of a simulation. States can have any name 170 that has a choice representation. GUI 132C provides three different types of simulation states values 172: starting, regular and ending. Starting states mark the starting point of a flow in a simulation. Similarly, ending states mark the ending of a flow in a simulation. Regular states can be described as a “stepping” state in the simulation flow.

FIG. 1E depicts GUI 132D of a fourth step in which users are enabled to use a node-edge graph canvas to create simulation flow graphs using the states that were created in GUI 132C at the previous step. Each node 174 in the graph represents a simulation step and each edge 176 establishes a way-point between two states. When controller 110 detects a user connecting two state nodes, controller 110 causes GUI 132E of FIG. 1F to appear to prompt the user to add rewards to reinforce a particular outcome for the simulation via logical operators 170, 172, 174, 176, 178. GUI 132E provides the user with the option to add rewards of different quantities to a way-point. Adding a reward means configuring and mapping conditional operations to input factors to reinforce a choice or outcome.

For example, controller 110 may detect receiving factors for a scenario where the desired outcome is to have more happy pets. In this scenario, controller 110 may detect the user setting up a logical graph where how hungry a dog is relates to how happy a dog is. Specifically, in this scenario a “hungry” dog has a “negative” happiness value and a “not hungry” dog has a “positive” happiness value. Controller 110 enables GUI 132E to set a reward to reinforce this outcome, where the hunger of the dog can be an input categorical factor that can be set to “hungry,” “content,” or “starving,” etc. In order to increase the chances of getting more happy dogs in the simulation controller 110 reinforces this action/choice by setting a reward, which is a numeric value when the dog hunger becomes “equal” to the state “content.” Controller 110 may further prompt the user to increase the value of the cumulative metric, which in this case would be a state of happiness of the dog. As a result, during the simulation, the more the dog state of “hunger” is equal to “content” the higher the chances of the dog being happy at the end of the simulation.

Finally, FIG. 1G depicts GUI 132F in which users can review and edit the configuration of the simulation. GUI 132F provides a review dashboard with sectional insights 180 to different aspects of the configuration of the simulation. These insights may include in-detail facts about the factors, statistical relationships, time series, simulation states, rewards, and the like of the full logical graph created by the user. GUI 132F also enables the user to set other parameters such as how many choices and actors/agents should be generated. GUI 132F also enables of combining simulations with cumulative metrics result from other (e.g., previously ran) simulations.

Controller 110 enables users to retrain reinforcement learning model 120 as many times as needed to get desired results. For example, controller 110 enables retraining reinforcement learning model 120 by enabling a user to edit existing rewards and/or add new ones, edit or create new simulation flows, and/or run new jobs. In such an example, if controller 110 detects changes to the states and rewards when a job is run, controller 110 will retrain the reinforcement learning model 120.

Controller 110 also enables the combination of simulations, such that each simulation is “subgraph” with the full logical graph that goes into a complete simulation. Combined simulations enable users to inject cumulative metrics and combine a simulation result with another simulation. As an example, a user may evaluate a scenario regarding how likely it is that customers may leave a telecommunications carrier due to their happiness with their service, where this happiness depends on how often the customer experiences different network outages. In this scenario, controller 110 may first enable the creation of a network service simulation that includes such factors as weather, maintenance, technician counts, location, and districts, with an additional cumulative metric regarding whether the network service is up or down. Controller 110 would then enable the creation of another simulation to synthesize customers which would include factors such as billing issues, average price of equipment, long wait times, and the cumulative metric called happiness. From here, controller 110 would enable the combination of the two sub-graphs into a single logical graph for a single combined simulation, such that the cumulative metric that determines whether the network service is up or down is injected into the customer simulation where the customer simulation can make use of that metric result to train the reinforcement model, make choices during the simulation run, and generate results where customers stay or leave the service based on their happiness based on network outages.

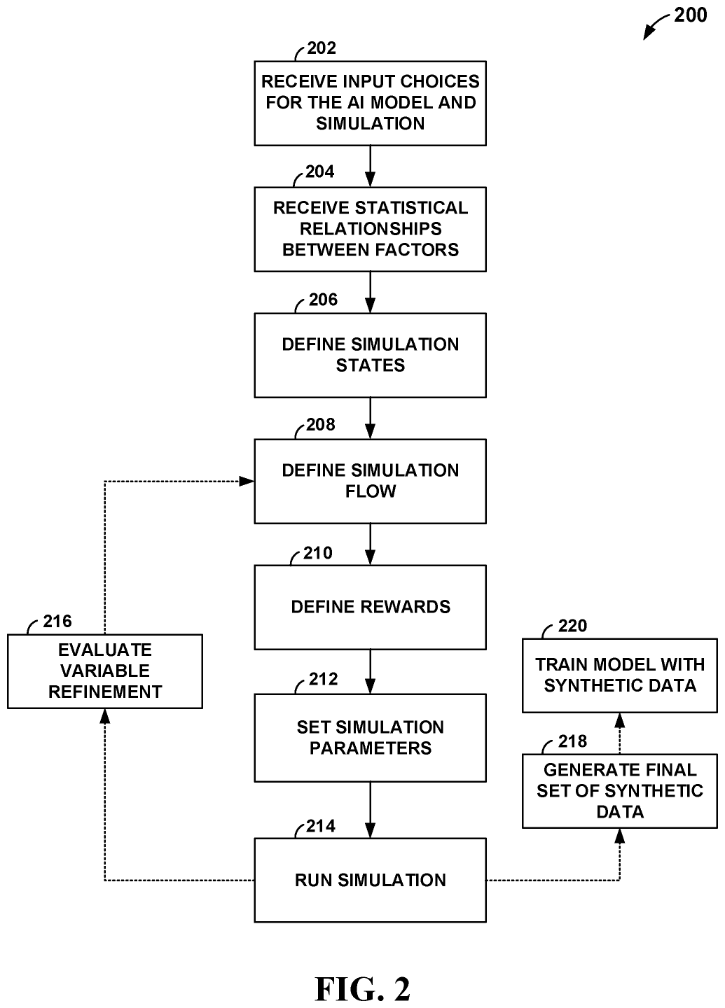

Controller 110 may manage the generation of synthetic data according to flowchart 200 depicted in FIG. 2. Flowchart 200 of FIG. 2 is discussed with relation to FIG. 1A for purposes of illustration, though it is to be understood that other environments with other components may be used to execute flowchart 200 of FIG. 2 in other examples. Further, in some examples controller 110 may execute a different method than flowchart 200 of FIG. 2, or controller 110 may execute a similar method with more or less steps in a different order, or the like.

Controller 110 receives input choices for the AI model and simulation (202). Controller 110 receives these through GUI 132. Controller 110 may receive this through a web application being access on user device 130. Controller 110 receives statistical relationships between factors (204). Controller 110 may receive these relationships as a result of a user graphically manipulating nodes 166, such as by placing edges 168 between them.

Controller 110 defines simulation states (206). Controller 110 may define these simulation states responsive to receiving information from a user regarding these simulation states (e.g., receiving it through GUI 132). Controller 110 defines simulation flow (208). In some examples, the simulation flow is equivalent to the logical graph discussed herein. Controller 110 defines rewards (210). Controller 110 may define rewards as a result of receiving reward data as sent over GUI 132. Controller 110 also sets simulation parameters (212), such as in response to receiving these parameters via GUI 132.

In some examples, controller 110 may actively suggest some of the input, relationships, states, flow, rewards, or parameters from 202-212. For example, controller 110 may be comparing received information and definitions to historical information from historical database 140. In examples where controller determines a high match between definitions and input received via GUI 132 with a highly rated model saved within historical database 140, controller 110 may recommend some relationships/states/flow/rewards from that highly-rated model within GUI 132. In some examples, controller 110 may specifically provide links to and/or data of the highly-rated model, so that a user may more fully understand the suggestion before deciding.

Controller 110 runs the simulation (214). Controller 110 may run the simulation by feeing the complete logical graph generated via GUI 132 into reinforcement learning model 120. Controller 110 evaluates variable refinement (216). For example, controller 110 evaluates whether or not the reinforcement learning model 120 generates data that appears to be robust and accurate. For another example, controller 110 may evaluate rules of reinforcement learning model 120, and/or any variables of the current logical graph, to see if anything could be improved. In some examples, controller 110 may determine that the data has a deficiency, in response to which controller 110 provides such a notification to a user. For another example, controller 110 may receive a notification that a user wants to provide additional refinement to the logical graph. In either example, controller 110 may repeat some steps of 202-212 to refine the process, such as returning to step 208 as depicted in flowchart 200.

Eventually, following running a simulation (214), controller 110 generates a full set of synthetic data (218) and determines that the resultant data is satisfactory. In response to this, controller 110 submits this resultant synthetic data as satisfactory, such that a new data is trained with the synthetic data (220). Training the model with the synthetic data includes both a training step and a verification stage, both of which are conducted with the synthetic data.

As described above, controller 110 may include or be part of a computing device that includes a processor configured to execute instructions stored on a memory to execute the techniques described herein. For example, FIG. 3 is a conceptual box diagram of a computing environment 300 with a computer 301 that can host controller 110. While computer 301 is depicted as a single entity (e.g., within a single housing) for the purposes of illustration, in other examples, computer 301 may include two or more discrete physical systems (e.g., within two or more discrete housings).

Computer 301 includes persistent storage 313, which in some cases (not depicted) may include threshold and preference data. Threshold and preference data may include thresholds that define a manner in which controller 110 is to manage generation of synthetic data. For example, threshold and preference data may include thresholds at which controller 110 suggests that a user provide a reward, or use a specific state or factor (e.g., because another similar simulation used the same state or factor), or the like. Put differently, threshold and performance data may define a manner in which controller 110 monitors actions of a user within GUI 132 and suggests various actions as a result of determining that this action is likely to align with and be helpful to a simulation being put together by the user. For example, continuing the example in which a dog was hungry up above, controller 110 may be configured to suggest further adding a states and factors relating to a dog being thirsty in response to determining that adding such states and factors would improve an accuracy of the eventual synthetic data generated by controller using reinforcement learning model 120.

Memory 230 may further include machine learning techniques that controller 110 may use to improve a process of managing the generation of synthetic data as described herein over time. Machine learning techniques can comprise algorithms or models that are generated by performing supervised, unsupervised, or semi-supervised training on a dataset, and subsequently applying the generated algorithm or model to manage synthetic data generation. Using these machine learning techniques, controller 110 may improve an ability to manage synthetic data generation. For example, controller 110 may track how certain types of states, rewards, factors, etc., as used in a logical graph result in eventual synthetic data that causes a better or worse performing model. Where controller 110 determines that certain types of factors, rewards, states, etc., have a negative correlation with the eventual accuracy of the model that is trained with the generated synthetic data, controller 110 may provide prompts to a user to not use such factors/rewards/states. Alternatively, where one identified element of a logical graph has been found to correlate with better performing models, controller 110 may learn to suggest such an element in future instances when appropriate.

Machine learning techniques can include, but are not limited to, decision tree learning, association rule learning, artificial neural networks, deep learning, inductive logic programming, support vector machines, clustering, B ayesian networks, reinforcement learning, representation learning, similarity/metric training, sparse dictionary learning, genetic algorithms, rule-based learning, and/or other machine learning techniques. Specifically, machine learning techniques can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, Deep Q-learning, (MADRL) multi-agent deep reinforcement learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning algorithms.

Computing environment 300 contains an example of an environment for the execution of at least some of the computer code involved in performing the inventive methods, such as synthetic data generation techniques 399. In addition to synthetic data generation techniques 399, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and synthetic data generation techniques 399, as identified above), peripheral device set 314 (including user interface (UI) device set 323, storage 324, and Internet of Things (IoT) sensor set 325), and network module 315. Remote server 104 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in synthetic data generation techniques 399 in persistent storage 313.

Communication fabric 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in synthetic data generation techniques 399 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-situation data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

What is claimed is:

1. A computer-implemented method comprising:
guiding, using a graphical user interface (GUI), a user to generate a logical graph that represents how real data is generated in a situation; and
simulating, using an artificial intelligence (AI) model, the situation a number of times by having the AI model choose paths through the logical graph to generate synthetic data that is representative of the real data, such that the synthetic data can be used for training other AI models.

2. The method of claim 1, wherein the logical graph is a simplified version of the situation, the method further comprising:
adding, via analyzing the simulations of the AI model, additional nuanced steps within the logical graph.

3. The method of claim 1, wherein guiding the user to generate the logical graph includes receiving positive or negative rewards associated with steps of the logical graph, wherein:
the positive or negative rewards define why agents of the AI model would choose different paths of the logical graph; and
simulating the situation includes training the AI model by having the agents of the AI model choose the different paths based on the positive or negative rewards.

4. The method of claim 3, wherein the logical graph includes a plurality of nodes connected via edges, the method further comprising using a graphical processing unit to graphically simulate the situation the number of times using the AI model.

5. The method of claim 1, wherein the logical graph includes a plurality of subgraphs generated by the user via the GUI, wherein subsequent subgraphs flow logically into each other to create the logical graph.

6. The method of claim 5, wherein some subgraphs of the plurality of subgraphs are alternates of each other within the situation.

7. The method of claim 1, further comprising training another AI model with the synthetic data such that no real-world data is used to train the another AI model.

8. The method of claim 1, wherein guiding the user to generate the logical graph includes recommending some steps for the user to add into the logical graph.

9. The method of claim 8, wherein a neural network uses pattern matching to recommend the some steps.

10. A system comprising:
a processor; and
a memory in communication with the processor, the memory containing instructions that, when executed by the processor, cause the processor to:
guide, using a graphical user interface (GUI), a user to generate a logical graph that represents how real data is generated in a situation; and
simulate, using an artificial intelligence (AI) model, the situation a number of times by having the AI model choose paths through the logical graph to generate synthetic data that is representative of the real data, such that the synthetic data can be used for training other AI models.

11. The system of claim 10, wherein the logical graph is a simplified version of the situation, the memory containing additional instructions that, when executed by the processor, cause the processor to:
adding, via analyzing the simulations of the AI model, additional nuanced steps within the logical graph.

12. The system of claim 10, wherein guiding the user to generate the logical graph includes receiving positive or negative rewards associated with steps of the logical graph, wherein:
the positive or negative rewards define why agents of the AI model would choose different paths of the logical graph; and
simulating the situation includes training the AI model by having the agents of the AI model choose the different paths based on the positive or negative rewards.

13. The system of claim 12, wherein the logical graph includes a plurality of nodes connected via edges, the memory containing additional instructions that, when executed by the processor, cause the processor to use a graphical processing unit to graphically simulate the situation the number of times using the AI model.

14. The system of claim 1, wherein the logical graph includes a plurality of subgraphs generated by the user via the GUI, wherein subsequent subgraphs flow logically into each other to create the logical graph.

15. The system of claim 14, wherein some subgraphs of the plurality of subgraphs are alternates of each other within the situation.

16. The system of claim 10, the memory containing additional instructions that, when executed by the processor, cause the processor to train another AI model with the synthetic data such that no real-world data is used to train the another AI model.

17. The system of claim 10, wherein guiding the user to generate the logical graph includes recommending some steps for the user to add into the logical graph.

18. The system of claim 17, wherein a neural network uses pattern matching to recommend the some steps.

19. A computer program product, the computer program product comprising a computer readable storage medium having program instructions embodied therewith, the program instructions executable by a computer to cause the computer to:
guide, using a graphical user interface (GUI), a user to generate a logical graph that represents how real data is generated in a situation; and
simulate, using an artificial intelligence (AI) model, the situation a number of times by having the AI model choose paths through the logical graph to generate synthetic data that is representative of the real data, such that the synthetic data can be used for training other AI models.

20. The computer program product of claim 19, wherein the logical graph is a simplified version of the situation, the computer readable storage medium containing additional program instructions that, when executed by the computer, cause the computer to:
adding, via analyzing the simulations of the AI model, additional nuanced steps within the logical graph.
